(19) United States
(12) Patent Application Publication
(10) Pub. No.: US 2023/0419279 A1
(43) Pub. Date: Dec. 28, 2023

(54) SYSTEMS AND METHODS FOR REAL-TIME BILLPAY USING CREDIT-BASED PRODUCTS

(71) Applicant: JPMORGAN CHASE BANK, N.A., New York, NY (US)

(72) Inventors: Andrea COUTU, Denver, CO (US); Riti SINGHAL, Sayreville, NJ (US); Michael HORGAN, Wilmington, DE (US); Othman ELGOUMHI, Aliso Viejo, CA (US); Rimoun GHALY, Anaheim, CA (US); Baxter P CAMPBELL, Santa Ana, CA (US); Matthew D ROSE, Santa Ana, CA (US); Ken GUTIERREZ, Lakewood, CA (US); Elmahdi ERRAJI, North Tustin, CA (US); Brendan CROTTY, Wayne, PA (US); Bill SMART, Pitman, NJ (US); Jeffrey LIN, Rancho Palos Verdes, CA (US); O'Brian SANTOS, Irvine, CA (US); Abdallah Mancour BILLAH, Lake Forest, CA (US); Rachel WULF, Philadelphia, PA (US); Nicholas R APOSTOLU, Philadelphia, PA (US); Krishnan NAIR, San Jose, CA (US); Victoria LEE, Florham Park, NJ (US); Mark S WEBER, Bear, DE (US)

(21) Appl. No.: 18/326,351

(22) Filed: May 31, 2023

Related U.S. Application Data
(60) Provisional application No. 63/366,899, filed on Jun. 23, 2022.

(51) Int. Cl. G06Q 20/10

(52) U.S. Cl. CPC G06Q 20/102

(57) ABSTRACT

A method for real-time billpay using credit-based products may include a billpay computer program: receiving an electronic file identifying approved merchant billpay participants from a payment processor computer program; receiving an invoice from one of the approved billpay merchant participants, the invoice comprising an embedded statement and a merchant name, an amount due, and a due date; receiving access to the invoice via a first customer user interface, wherein the first customer user interface is configured to access the embedded statement in a second customer interface, wherein the embedded statement is inaccessible to the first customer interface; presenting, in the first customer interface, the merchant name, the amount due, and the due date; receiving, from the first customer interface, approval to pay the invoice; determining that the approved billpay merchant participant is identified in the electronic file; and executing payment for the invoice via the payment processor computer program.

### RELATED APPLICATIONS

This application claims priority to, and the benefit of, U.S. Provisional Patent Application Ser. No. 63/366,899, filed Jun. 23, 2023, the disclosure of which is hereby incorporated, by reference, in its entirety.

### BACKGROUND OF THE INVENTION

### 1. Field of the Invention

Embodiments relate to systems and methods for real-time billpay using credit-based products.

### 2. Description of the Related Art

Many banks offer their customers the ability to pay bills online using an online billpay process. The customer enters payee information, payment information, and then the bank sends the payee a check, or transfers the funds to a payee account.

### SUMMARY OF THE INVENTION

Systems and methods for real-time billpay using credit-based products are disclosed. According to an embodiment, a method for real-time billpay using credit-based products may include: (1) receiving, at a billpay computer program executed by a financial institution backend, an electronic file identifying a plurality of approved merchant billpay participants from a payment processor computer program; (2) exposing, by the billpay computer program, an application programming interface to the approved merchant billpay participants; (3) receiving, by the billpay computer program, an invoice from one of the approved billpay merchant participants, the invoice comprising an embedded statement and a merchant name, an amount due, and a due date; (4) receiving, by the billpay computer program, access to the invoice via a first customer user interface, wherein the first customer user interface may be configured to access the embedded statement in a second customer interface, wherein the first customer user interface and the second customer interface are isolated from each other such that the embedded statement is inaccessible to the first customer interface; (5) presenting, by the billpay computer program and in the first customer interface, the merchant name, the amount due, and the due date; (6) receiving, by the billpay computer program and from the first customer interface, approval to pay the invoice; (7) determining, by the billpay computer program, that the approved billpay merchant participant is identified in the electronic file; and (8) executing, by the billpay computer program, payment for the invoice to the approved billpay merchant participant via the payment processor computer program, wherein the payment processor computer program may be configured to reject the payment in response to a payment velocity for the approved billpay merchant participant being greater than a velocity threshold for a first period of time.

In one embodiment, the electronic file may also include an identification of invoice field requirements for one of the approved merchant billpay participants.

In one embodiment, the embedded statement may include an explanation of benefits.

In one embodiment, the embedded statement may include personal health information.

In one embodiment, the payment processor computer program may be further configured to reject the payment in response to a cumulative payment amount for the approved billpay merchant being greater than a cumulative payment threshold for a second period of time.

In one embodiment, the second customer interface may include an iFrame or a lightbox.

In one embodiment, the payment processor computer program may be further configured to update the electronic file to remove the approved merchant billpay participant in response to a payment velocity being greater than a velocity threshold for the first period of time.

According to another embodiment, a system may include a payment processor backend executing a payment processor computer program; and a financial institution backend executing a billpay computer program. The payment processor computer program provides an electronic file identifying a plurality of approved merchant billpay participants to the billpay computer program. The billpay computer program exposes an application programming interface to the approved merchant billpay participants; receives an invoice from one of the approved billpay merchant participants, the invoice comprising an embedded statement and a merchant name, an amount due, and a due date; receives access to the invoice via a first customer user interface executed by a customer electronic device, wherein the first customer user interface may be configured to access the embedded statement in a second customer interface, wherein the first customer user interface and the second customer interface are isolated from each other such that the embedded statement is inaccessible to the first customer interface; presents the merchant name, the amount due, and the due date in the first customer interface; receives approval to pay the invoice from the first customer interface; determines that the approved billpay merchant participant is identified in the electronic file; and executes payment for the invoice to the approved billpay merchant participant via the payment processor computer program. The payment processor computer program monitors a payment velocity for the approved billpay merchant participant and rejects the payment in response to the payment velocity being greater than a velocity threshold for a first period of time.

In one embodiment, the electronic file may also include an identification of invoice field requirements for one of the approved merchant billpay participants.

In one embodiment, the embedded statement may include an explanation of benefits.

In one embodiment, the embedded statement may include personal health information.

In one embodiment, the payment processor computer program may be further configured to reject the payment in response to a cumulative payment amount for the approved billpay merchant being greater than a cumulative payment threshold for a second period of time.

In one embodiment, the second customer interface may include an iFrame or a lightbox.

In one embodiment, the payment processor computer program may be further configured to update the electronic file to remove the approved merchant billpay participant in response to the a payment velocity being greater than a velocity threshold for the first period of time.

According to another embodiment, a non-transitory computer readable storage medium may include instructions stored thereon, which when read and executed by one or more computer processors, cause the one or more computer processors to perform steps comprising: receiving an electronic file identifying a plurality of approved merchant billpay participants from a payment processor computer program; exposing an application programming interface to the approved merchant billpay participants; receiving an invoice from one of the approved billpay merchant participants, the invoice comprising an embedded statement and a merchant name, an amount due, and a due date; receiving access to the invoice via a first customer user interface, wherein the first customer user interface may be configured to access the embedded statement in a second customer interface, wherein the second customer interface may include an iFrame or a lightbox and the first customer user interface and the second customer interface are isolated from each other such that the embedded statement is inaccessible to the first customer interface; presenting the merchant name, the amount due, and the due date in the first customer interface; receiving approval to pay the invoice from the first customer interface; determining that the approved billpay merchant participant is identified in the electronic file; and executing payment for the invoice to the approved billpay merchant participant via the payment processor computer program, wherein the payment processor computer program may be configured to reject the payment in response to a payment velocity for the approved billpay merchant participant being greater than a velocity threshold for a first period of time.

In one embodiment, the electronic file may also include an identification of invoice field requirements for one of the approved merchant billpay participants.

In one embodiment, the embedded statement may include an explanation of benefits.

In one embodiment, the embedded statement may include personal health information.

In one embodiment, the payment processor computer program may be further configured to reject the payment in response to a cumulative payment amount for the approved billpay merchant being greater than a cumulative payment threshold for a second period of time.

In one embodiment, the payment processor computer program may be further configured to update the electronic file to remove the approved merchant billpay participant in response to the a payment velocity being greater than a velocity threshold for the first period of time.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 depicts a system for real-time billpay using credit-based products according to an embodiment;

FIG. 2 depicts a method for real-time billpay using credit-based products according to an embodiment;

FIG. 3 depicts an exemplary computing system for implementing aspects of the present disclosure.

### DETAILED DESCRIPTION OF PREFERRED EMBODIMENTS

Embodiments may include a real-time integration via REST API between a financial institution and a payment processor that allows the payment itself to be processed real-time, and posted directly to a customer's portal for reconciliation at the same exact time. This lets customers be aware of payments from this channel right away and apply any payments directly to their balances right away without waiting for a mailed payment or end of day file to come through.

Embodiments may have particular utility in the context of healthcare payments.

As part of fraud monitoring, embodiments may monitor payment velocity and amount to identify when a client (e.g., a merchant) receives a suspiciously large amount or several amounts over the same minute, etc. When this is identified, payments to the merchant are suspended and while the transaction is processed, funding may be suspended pending confirmation that the transaction(s) are legitimate. Any suspended merchant may be removed from such payment eligibility until the merchant is unsuspended.

Embodiments may send a message (e.g., an email, SMS, etc.) when a bill payment is received. The email may identify the payment source (e.g., a financial institution billpay website).

Embodiments may also use parsing logic to ensure that if a user first/last name is not collected through the payment source (e.g., a financial institution billpay website), the payment processor may automatically populate these fields with the account holder first and last name.

Embodiments may use RSA encryption to payments so that the payment processor may collect payments through a mobile application for a financial institution.

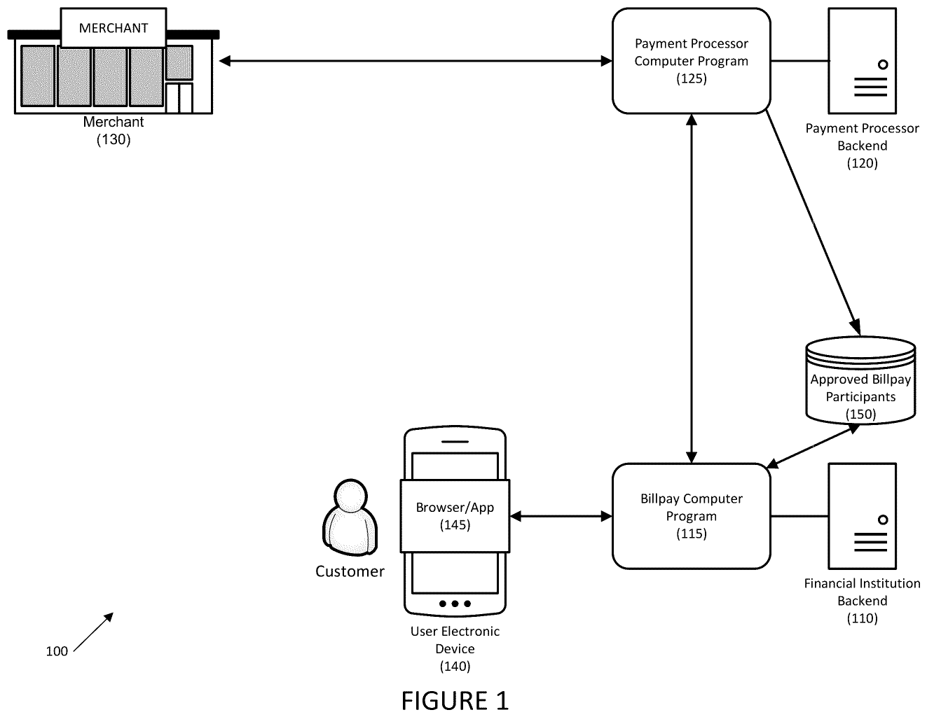

Referring to FIG. 1, a system for real-time billpay using credit-based products is disclosed according to one embodiment. System 100 may include financial institution backend 110, which may be a server (e.g., cloud-based and/or physical), computers, etc. Financial institution backend 110 may execute billpay computer program 115, which may interface with browser/application 145 executed by user electronic device 140, database of approved merchant billpay participants 150, and payment processor computer program 125. Payment processor computer program 125 may be executed by payment processor backend 120, which may be a server (e.g., cloud-based and/or physical), computers, etc.

Payment processor computer program 125 may interface with merchant 130. In one embodiment, merchant 130 may be a provider that may be subject to the Health Insurance Portability and Accountability Act of 1996 (HIPAA), including the privacy requirements of HIPAA. Thus, merchant 130 may not be permitted to share certain patient information, such as personal health information (PHI) with, for example, financial institution backend 110.

In one embodiment, the connection between payment processor computer program 125 and billpay computer program 115 may be a single sign on connection so that the customer may log in to the billpay computer program and to the merchant using a single sign on.

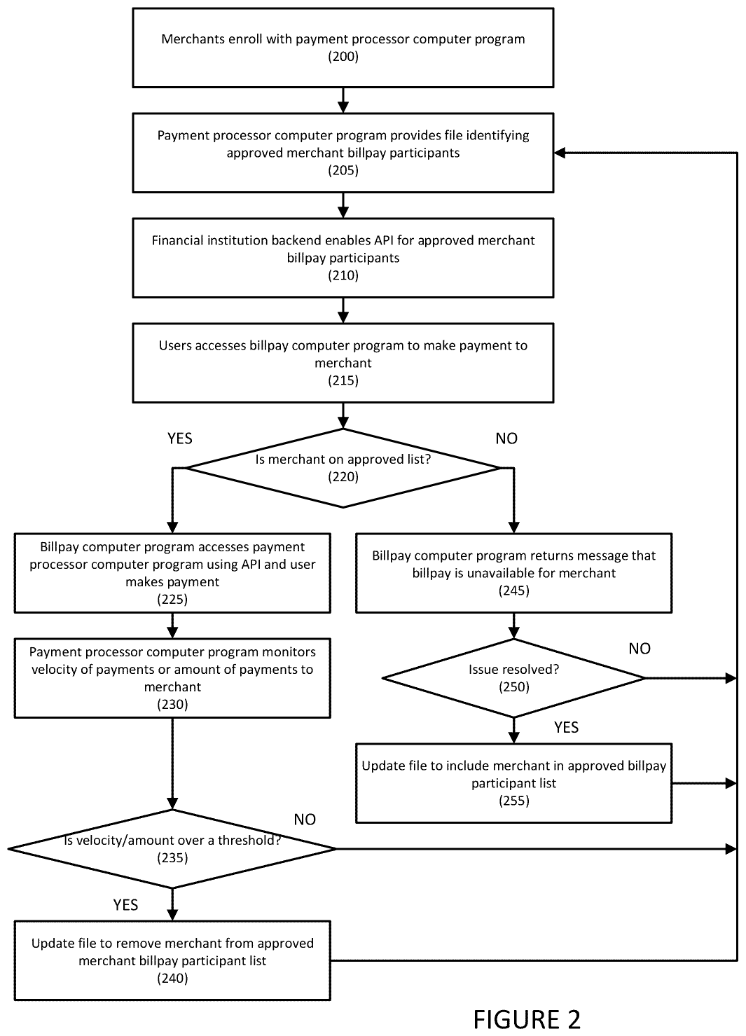

Referring to FIG. 2, a method for real-time billpay using credit-based products is disclosed according to one embodiment.

In step 200, a merchant, such as a healthcare provider, may enroll with a payment processor for an on-line bill payment service. In one embodiment, the merchant may provide its payment field and formatting requirements to a payment processor computer program executed by an electronic device for the payment processor for payments. For example, one merchant may want a customer account number and a zip code; another merchant may require the customer's date of birth. The payment processor computer program may receive the requirements for each merchant so that the proper information is collected from the customer during payment.

In one embodiment, each merchant may enroll separately with the payment processor.

In step 205, the payment processor computer program may provide a file identifying approved merchant billpay participants to a billpay computer program executed by a financial institution backend. The billpay computer program may store the approved merchant billpay participants in a database.

In one embodiment, the file may further identify the field requirements for the merchants so that the proper information is collected during payment.

In step 210, the financial institution backend may enable an Application Programming Interface (API) for the approved billpay participants. The approved billpay participants may submit invoices to the financial institution backend using the API.

In one embodiment, the invoices may include information necessary for the customer to make a payment, but may not include PHI.

In another embodiment, the invoice may include an embedded statement, such as detailed billing information, an explanation of benefits, etc. that may include PHI. The statement may be encrypted so that the PHI is not shared with the financial institution backend. The embedded statement may be opened in a separate window, a lightbox, an iFrame, etc., or locally on the customer's electronic device.

In step 215, a customer may access the billpay computer program at the customer's financial institution to make payment to the merchant. In one embodiment, the customer may be presented with invoice information, such as the merchant's name, the amount due, and the due date.

In one embodiment, the customer may access the billpay computer program in a first customer interface, and the embedded statement in a second customer interface, such as a separate browser window, a lightbox, an iFrame, etc., that may be hosted by the merchant. The second customer interface may be isolated from the financial institution backend for compliance with HIPAA, for example. Thus, the customer's PHI is not exposed to the financial institution backend.

In one embodiment, using the second customer interface, the customer may access other statements from the merchant or another merchant, past payments, etc.

In another embodiment, the customer may access the embedded statement locally using a local application.

In step 220, if the merchant is on the list of approved merchant billpay participants, in step 225, the billpay computer program may access the payment processor computer program using the API, and the customer may make a payment. The payment may be for the requested amount, a different amount, etc.

In step 230, the payment processor computer program may monitor a velocity of payments or an amount of payments to the merchant. In step 235, if the velocity and/or amount of payments is over a threshold velocity or threshold cumulative payment amount for a period of time, in step 240, the payment processor computer program may update the approved merchant billpay participant list to remove merchant from the list.

In one embodiment, the period of time for the payment velocity and the period of time for the payment amount may be the same, or they may differ.

If, in step 220, the merchant is not on the approved merchant billpay participant list, in step 245, the billpay computer program may return a message to the user that billpay is unavailable for the merchant. The user may then make payment by another mechanism.

In step 250, if the issue with the merchant is resolved, in step 255, the billpay computer program may update the approved merchant billpay list to include the merchant and the process may continue to step 205.

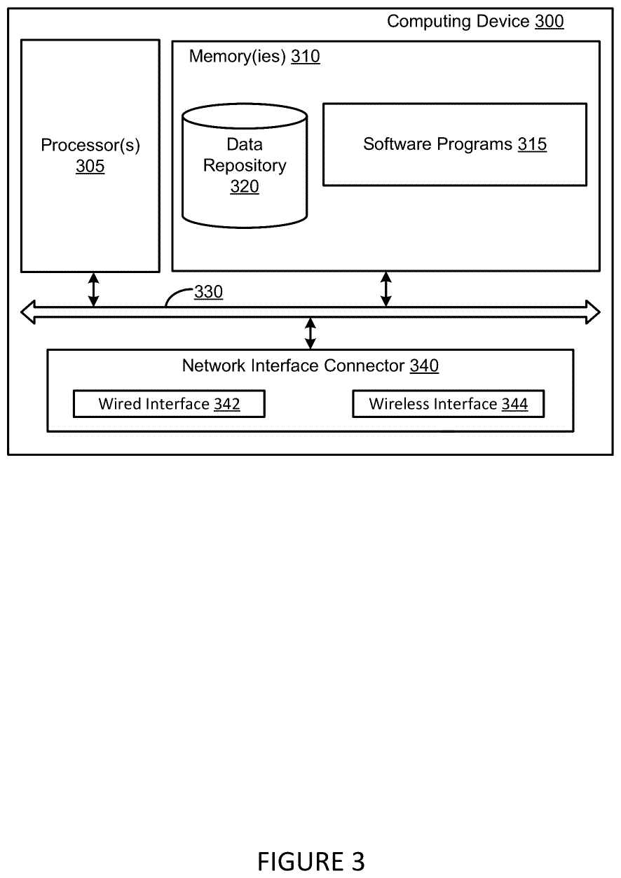

FIG. 3 depicts an exemplary computing system for implementing aspects of the present disclosure. FIG. 3 depicts exemplary computing device 300. Computing device 300 may represent the system components described herein. Computing device 300 may include processor 305 that may be coupled to memory 310. Memory 310 may include volatile memory. Processor 305 may execute computer-executable program code stored in memory 310, such as software programs 315. Software programs 315 may include one or more of the logical steps disclosed herein as a programmatic instruction, which may be executed by processor 305. Memory 310 may also include data repository 320, which may be nonvolatile memory for data persistence. Processor 305 and memory 310 may be coupled by bus 330. Bus 330 may also be coupled to one or more network interface connectors 340, such as wired network interface 342 or wireless network interface 344. Computing device 300 may also have user interface components, such as a screen for displaying graphical user interfaces and receiving input from the user, a mouse, a keyboard and/or other input/output components (not shown).

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized

processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method for real-time billpay using credit-based products, comprising:
receiving, at a billpay computer program executed by a financial institution backend, an electronic file identifying a plurality of approved merchant billpay participants from a payment processor computer program;
exposing, by the billpay computer program, an application programming interface to the approved merchant billpay participants;
receiving, by the billpay computer program, an invoice from one of the approved billpay merchant participants, the invoice comprising an embedded statement and a merchant name, an amount due, and a due date;
receiving, by the billpay computer program, access to the invoice via a first customer user interface, wherein the first customer user interface is configured to access the embedded statement in a second customer interface, wherein the first customer user interface and the second customer interface are isolated from each other such that the embedded statement is inaccessible to the first customer interface;
presenting, by the billpay computer program and in the first customer interface, the merchant name, the amount due, and the due date;
receiving, by the billpay computer program and from the first customer interface, approval to pay the invoice;
determining, by the billpay computer program, that the approved billpay merchant participant is identified in the electronic file; and
executing, by the billpay computer program, payment for the invoice to the approved billpay merchant participant via the payment processor computer program, wherein the payment processor computer program is configured to reject the payment in response to a payment velocity for the approved billpay merchant participant being greater than a velocity threshold for a first period of time.

2. The method of claim 1, wherein the electronic file further comprises an identification of invoice field requirements for one of the approved merchant billpay participants.

3. The method of claim 1, wherein the embedded statement comprises an explanation of benefits.

4. The method of claim 1, wherein the embedded statement comprises personal health information.

5. The method of claim 1, wherein the payment processor computer program is further configured to reject the payment in response to a cumulative payment amount for the approved billpay merchant being greater than a cumulative payment threshold for a second period of time.

6. The method of claim 1, wherein the second customer interface comprises an iFrame or a lightbox.

7. The method of claim 1, wherein the payment processor computer program is further configured to update the electronic file to remove the approved merchant billpay participant in response to the a payment velocity being greater than a velocity threshold for the first period of time.

8. A system, comprising:
a payment processor backend executing a payment processor computer program; and
a financial institution backend executing a billpay computer program;
wherein:
the payment processor computer program provides an electronic file identifying a plurality of approved merchant billpay participants to the billpay computer program;
the billpay computer program exposes an application programming interface to the approved merchant billpay participants;
the billpay computer program receives an invoice from one of the approved billpay merchant participants, the invoice comprising an embedded statement and a merchant name, an amount due, and a due date;
the billpay computer program receives access to the invoice via a first customer user interface executed by a customer electronic device, wherein the first customer user interface is configured to access the embedded statement in a second customer interface, wherein the first customer user interface and the second customer interface are isolated from each other such that the embedded statement is inaccessible to the first customer interface;
the billpay computer program presents the merchant name, the amount due, and the due date in the first customer interface;
the billpay computer program receives approval to pay the invoice from the first customer interface;
the billpay computer program determines that the approved billpay merchant participant is identified in the electronic file;
the billpay computer program executes payment for the invoice to the approved billpay merchant participant via the payment processor computer program;
the payment processor computer program monitors a payment velocity for the approved billpay merchant participant and rejects the payment in response to the payment velocity being greater than a velocity threshold for a first period of time.

9. The system of claim 8, wherein the electronic file further comprises an identification of invoice field requirements for one of the approved merchant billpay participants.

10. The system of claim 8, wherein the embedded statement comprises an explanation of benefits.

11. The system of claim 8, wherein the embedded statement comprises personal health information.

12. The system of claim 8, wherein the payment processor computer program is further configured to reject the payment in response to a cumulative payment amount for the approved billpay merchant being greater than a cumulative payment threshold for a second period of time.

13. The system of claim 8, wherein the second customer interface comprises an iFrame or a lightbox.

14. The system of claim 8, wherein the payment processor computer program is further configured to update the electronic file to remove the approved merchant billpay participant in response to the a payment velocity being greater than a velocity threshold for the first period of time.

15. A non-transitory computer readable storage medium, including instructions stored thereon, which when read and executed by one or more computer processors, cause the one or more computer processors to perform steps comprising:
receiving an electronic file identifying a plurality of approved merchant billpay participants from a payment processor computer program;
exposing an application programming interface to the approved merchant billpay participants;
receiving an invoice from one of the approved billpay merchant participants, the invoice comprising an embedded statement and a merchant name, an amount due, and a due date;
receiving access to the invoice via a first customer user interface, wherein the first customer user interface is configured to access the embedded statement in a second customer interface, wherein the second customer interface comprises an iFrame or a lightbox and the first customer user interface and the second customer interface are isolated from each other such that the embedded statement is inaccessible to the first customer interface;
presenting the merchant name, the amount due, and the due date in the first customer interface;
receiving approval to pay the invoice from the first customer interface;
determining that the approved billpay merchant participant is identified in the electronic file; and
executing payment for the invoice to the approved billpay merchant participant via the payment processor computer program, wherein the payment processor computer program is configured to reject the payment in response to a payment velocity for the approved billpay merchant participant being greater than a velocity threshold for a first period of time.

16. The non-transitory computer readable storage medium of claim 15, wherein the electronic file further comprises an identification of invoice field requirements for one of the approved merchant billpay participants.

17. The non-transitory computer readable storage medium of claim 15 wherein the embedded statement comprises an explanation of benefits.

18. The non-transitory computer readable storage medium of claim 15, wherein the embedded statement comprises personal health information.

19. The non-transitory computer readable storage medium of claim 15, wherein the payment processor computer program is further configured to reject the payment in response to a cumulative payment amount for the approved billpay merchant being greater than a cumulative payment threshold for a second period of time.

20. The non-transitory computer readable storage medium of claim 15, wherein the payment processor computer program is further configured to update the electronic file to remove the approved merchant billpay participant in response to the a payment velocity being greater than a velocity threshold for the first period of time.
